(19) United States
(12) Patent Application Publication
(10) Pub. No.: US 2015/0119076 A1
(43) Pub. Date: Apr. 30, 2015

(54) SELF-CALIBRATING MOBILE INDOOR LOCATION ESTIMATIONS, SYSTEMS AND METHODS

(71) Applicant: Ronald H. Cohen, Pasadena, CA (US)

(72) Inventor: Ronald H. Cohen, Pasadena, CA (US)

(73) Assignee: Nant Holdings IP, LLC, Culver City, CA (US)

(21) Appl. No.: 14/530,247

(22) Filed: Oct. 31, 2014

Related U.S. Application Data
(60) Provisional application No. 61/898,185, filed on Oct. 31, 2013.

(51) Int. Cl. G01S 5/02

(52) U.S. Cl. CPC G01S 5/0252; H04L 63/107
USPC 455/456.1

(57) ABSTRACT

A system for estimating a device's location is presented. Disclosed systems utilize a known digital map of an area to determine when a device's location violates one or more forbidden zones. When such an intrusion is detected, the system updates tunable parameters of a corresponding location estimation algorithm to minimize estimated intrusions. Thus, the location estimation algorithm can be self-calibrated based on real-time, in-the-field data.

This application claims priority to U.S. Provisional Application No. 61/898,185, filed Oct. 31, 2013. U.S. Provisional Application No. 61/898,185 and all other extrinsic references referenced herein are incorporated by reference in their entirety.

### FIELD OF THE INVENTION

The field of the invention is location determination technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Systems have been developed to determine the location of Handsets in locations where other navigation systems do not function well. Inside buildings, where GPS generally provides poor performance, some systems perform handset position determination by measuring RSS between Handsets and Beacons. Such systems require a priori calibration to determine the variation of RSS as a function of position, so that when real-time RSS measurements are performed such measurements can be compared against a “radio map” of RSS values vs. position and/or the distance between a handset and beacons can be computed based on a calibrated curve or function of distance vs. RSS, and from such individual distances a position can be estimated via triangulation.

Such calibration processes are onerous, usually involving a human operator walking through a Space of interest and recording RSS measurements in a Handset. Furthermore, the actual RSS diverges from the calibrated radio map and from the calibrated distance vs. RSS curves. Divergences can be caused by changes in Beacons (for example, Beacons can be added or removed or their RF characteristics can change), changes in the environment (for example, humans moving through the area and structural changes can affect radio frequency (RF) propagation and bounce), and differences in handsets (difference devices have different RF characteristics).

Others have put forth effort toward determining position of handsets based on detected signals. Examples include:

Turner et al. titled “On the Empirical Performance of Self-Calibrating WiFi Location Systems”, IEEE Conference on Local Computer Networks, 2011;

U.S. patent application Ser. No. 13/927,510 to Valaee et al. titled “System, Method and Computer Program for Dynamic Generation of a Radio Map”, filed Jun. 26, 2013, describes use of a compressive sensing algorithm;

U.S. Pat. No. 7,555,363 to Augenbraun et al. titled “Multi-Function Robotic Device”, filed Sep. 1, 2006, discusses use of localization and mapping techniques;

U.S. Pat. No. 8,290,511 to Burdo et al. titled “Venue Application for Mobile Station Position Estimation”, filed Sep. 30, 2010, describes using map information along with routing constraints to estimate mobile station locations;

U.S. patent application publication 2009/0306822 to Scalisi et al. titled “Apparatus and Method for Generating Position Fix of a Tracking Device in Accordance with a Subscriber Service Usage Profile to Conserve Tracking Device Power”, filed Jul. 31, 2009, also discusses use of restricted areas of a zone map in determining position fixes; and

U.S. patent application publication 2011/0196647 to Perala et al. titled “State Vector Estimation Using Constraint Derived from a Map”, filed internationally on Jul. 30, 2008, discusses using a state vector truncated based on constraints derived from a map.

Although the above cited references provide insight into various techniques for estimating a device location, they fail to provide insight into how to improve the overall estimation techniques based on map information. Ideally, map information would be fed back into the estimation techniques to improve the accuracy of the technique, especially when a device is found to violate a restricted space.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is a need to provide accurate mobile navigation without the use of GPS and that self-calibrates without the need for human intervention.

### SUMMARY OF THE INVENTION

The inventive subject matter provides apparatus, systems and methods in which a location estimation system can self-calibrate its location estimation algorithms by updating tunable parameters based on violations of known forbidden zones. One aspect of the inventive subject matter includes a system comprising a memory and a location estimation module. The memory stores a digital map of an area that includes forbidden zones, and software instructions representing a location estimation algorithm having tunable parameters.

In embodiments, the location estimation module is configured to obtain received signal strength of signals from one or more beacons (e.g., other mobile devices, access points, etc.). The module estimates a device's locations according to a location estimation algorithm as a function of the signal strength. The module further compares the estimated location against the Forbidden Zones of the map to determine if the device is located in a restricted space. If so, module can adjust the tunable parameters to reduce a cost function that reflects how the device intrudes into the Forbidden Zone. Thus, the adjusted parameters can be fed back into the estimation algorithm to minimize such errors (by eliminating the intrusion into the Forbidden Zone or reducing the degree to which the intrusion is occurring).

In embodiments, the location estimation module can use location estimation algorithms associated with other location estimation techniques (techniques using measurements other than RF signals) to estimate a location and compare it against a map with Forbidden Zones to determine whether the estimated location is potentially erroneous. If so, the tunable parameters of the algorithm can be adjusted so as to minimize the intrusion into a Forbidden Zone (or the extent thereof).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an overview of the system according to embodiments of the inventive subject matter.

FIG. 2 is an overview of position determination of a handset with a space based on signal strength.

FIG. 3 is an illustrative example of a digital map of the space having Forbidden Zones.

FIG. 4 is an illustrative example of an application of the digital map having Forbidden Zones to the position determination of a handset within the space.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, “navigation” can refer to the estimating of a position within a space. This can include a trajectory or path through the space over time as well as a single position at a single point in time.

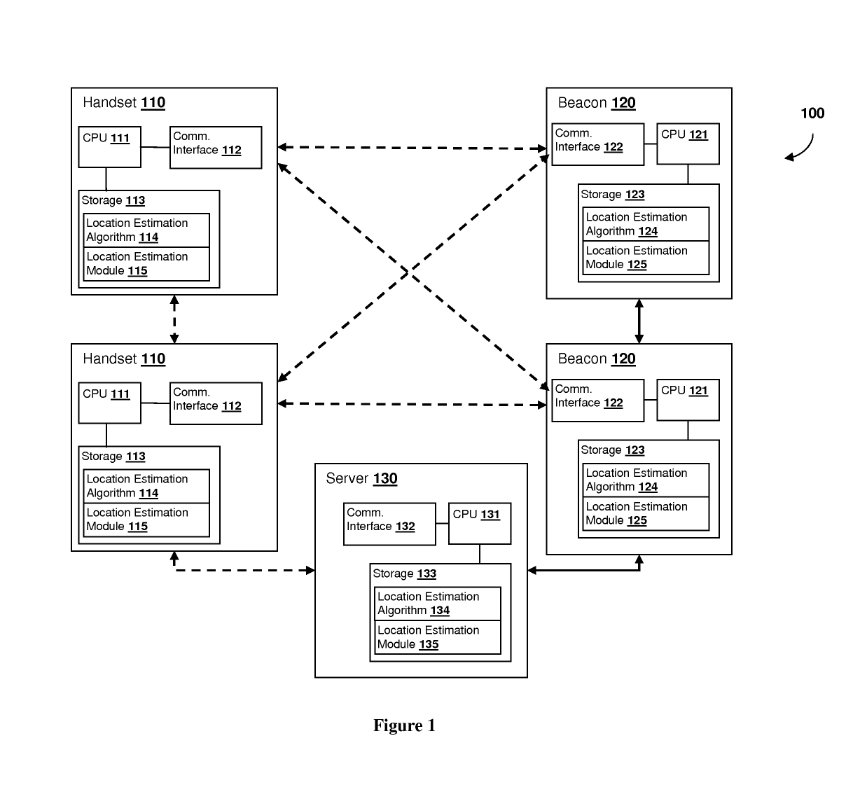

FIG. 1 illustrates an overview of an example system 100 according to embodiments of the inventive subject matter.

The system of the inventive subject matter includes one or more computing devices such as handsets 110 capable of sending and receiving radio signals via one or more communication interface(s) 112. Examples of suitable computing devices include mobile phones, tablets, portable game consoles, portable media player, phablets, and other portable computing devices. Although the term “handset” is used, it should be appreciated that the disclosed techniques can also be applied to vehicles, medical devices, or other mobile equipment.

The communication interface 112 can include any interface capable of receiving wireless radio signals. Communication interface 112 can include receive-only interfaces (i.e., the interface can only receive signals) as well as send-receive interfaces (i.e., enabling the receipt and transmission of a signal and, as such, data over a signal). Examples of contemplated communication interfaces include AM radio interfaces, FM radio interfaces, Wi-Fi interfaces, cellular interfaces, Bluetooth interfaces, NFC interfaces, etc. FIG. 1 illustrates the communication interfaces used among the components of system 100, whereby the broken-lined arrows indicate wireless communication only and the solid arrows indicate a communication that can be wireless, wired, or a combination of both wireless and wired.

As shown in FIG. 1, handset 110 includes one or more processors 111 that are programmed to execute the functions associated with the handset 110, including those functions and processes associated with the inventive subject matter. Handset 110 can also include a non-transitory computer-readable storage medium 113 (e.g., RAM, ROM, hard drive, flash drive, solid-state drive, etc.) that is configured to store instructions and data, including instructions and data associated with the inventive subject matter.

A handset 110 can communicate with other handsets 110 using wireless communication techniques such as those discussed herein, via communication interface 112 of each respective device. The handset 110 can further include one or more a user interface (e.g., keypad, touch-screen interface, joystick, gamepad, etc.), a display, a microphone, an audio output interface (e.g., headphones, speakers, etc.), sensory feedback interfaces (e.g., vibration feedback, notification LEDs, etc.), sensors (e.g., accelerometers, magnetometers, temperature sensors, pressure sensors, light sensors, contact sensors, barometers, camera, etc.), wired communication interfaces (e.g. USB, HDMI, etc.), infrared interfaces, GPS, etc.

The system 100 can include one or more beacons 120. As used herein, a beacon 120 generally refers to a radio device that communicates with other devices via a communication interface 122. Thus, a beacon 120 is capable of emitting radio frequency (“RF”) signals that can be detected by handsets 110. Examples of signals include WiFi, WiMAX, WiGIG, GSM, CDMA, Zigbee, AM signals, FM signals, NFC signals, etc.

Beacons 120 can be considered to be stationary sources of RF signals. A beacon 120 can be connected to a network such as the Internet and can enable handset 110 to communicate with such network via the beacon 120. Examples of beacons 120 can include Wi-Fi emitters (such as wireless routers, repeaters, access points, etc.), AM or FM radio emitters (e.g., in a radio station), cellular emitters (e.g., cellular towers, repeaters, etc.), Bluetooth interfaces, NFC interfaces, etc.

As shown in FIG. 1, beacons 120 include at least one processor 121 as well as a non-transitory computer-readable storage medium 123. Thus, the beacons 120 can be programmed to perform various functions associated with the inventive subject matter. However, in embodiments, a beacon 120 can simply be a “dumb” transmission device that transmits RF signals under the direction of a separate computing device to which it is communicatively coupled.

Beacons 120 can be communicatively coupled to one another for the purposes of exchanging data. As illustrated with the solid-lined arrow in FIG. 1, communications between beacons 120 can be via wired and/or wireless communication.

In embodiments, beacon 120 can include mobile or portable RF emitting devices, which can include devices such as mobile hotspots, vehicles, etc. In these embodiments, a handset 110 can also function as a beacon 120.

FIG. 1 also shows a server 130 that can be communicatively coupled to handset 110 and/or beacon 120. As used herein, a server generally refers to a computing device that communicates with a handset and/or a beacon via a network such as the Internet. In embodiments, the location estimation algorithm, location estimation module, map data and/or other instructions and data associated with the inventive subject matter can be stored on a server 130.

The location estimation system 100 includes a digital map of the space, stored on at least one non-transitory computer-readable memory. The at least one non-transitory computer-readable memory can be the memory internal to one or more handset(s) 110, one or more beacon(s) 120, a remote server 130, or other non-transitory computer-readable memory accessible to one or more of the components of system 100 via a communication network. The digital map can be a two-dimensional or three-dimensional representation of the space. The digital map can be generated based on blueprints, plans, drawings, publicly or privately available maps, photographs, video imagery, etc.

System 100 also includes at least one location estimation algorithm and at least one location estimation module. FIG. 1 shows location estimation algorithms 114, 124, 134 and location estimation modules 115, 125, 135 in each of the handsets 110, beacons 120, and server 130, respectively. In embodiments, all of these components can each have their respective location estimation algorithms and location estimation modules. In other embodiments, only some of the system components will have the location estimation algorithms and/or the location estimation modules (e.g., only the handsets 110, only the beacons 120, only the server 130, or some but not all handsets 110). At minimum, only a single combination of the location algorithm and the location estimation module is required in system 100. Thus, in embodiments, a single device (a single handset 110, single beacon 120, or a single server 130) can have both the location estimation algorithm and the location estimation module used for the entire system. As such, the processes and functions of the inventive subject matter associated with the location estimation algorithm and/or the location estimation module can be executed entirely by a handset 110, by a beacon 120 or by a server 130, or by a combination thereof. For the purposes of simplicity, the discussion of the location estimation algorithm and location estimation module will refer to those within handset 110 unless context dictates otherwise or is otherwise noted. It should be understood that, unless context dictates otherwise or is otherwise noted, the functions of the location estimation algorithm and location estimation module as executed by handset 110 similarly apply to the execution of the algorithm and module by beacon 120 and/or server 130.

The location estimation algorithm 114 is an algorithm that determines the position of handset 110 by using a function or curve that relates received signal strength (“RSS”) to distance from a beacon 120 and then triangulating distances from multiple beacons 120, or any other technique that estimates position from RSS. The estimation can include adjustments for handset characteristics (e.g., signal reception capacity, sensitivity to signals, processing and/or memory limitations, etc. of individual handsets). The estimation can interpolate between RSS values in a radio map or RSS vs. distance table/curve. Examples of suitable algorithms include linear functions (i.e. for an RSS vector input, applying a linear function whose output is position vector or state vector for the handset), Kalman filter algorithms, compressed sensing algorithms, etc. Other examples of suitable location estimation techniques are discussed in “On the Empirical Performance of Self-calibrating WiFi Location Systems” by Turner, et al, which is incorporated by reference in its entirety. The location estimation algorithm 114 can be stored on storage 113 as a set of computer-executable instructions that are executed by processor 111 to determine the handset 110's position in a particular space.

References to triangulation herein are used for illustrative purposes, and as such the radio navigation techniques are not to be interpreted as being limited only to triangulation. Other suitable radio navigation techniques include multilateration (MLAT), trilateration, and other radio navigation techniques. Similarly, the use of triangulation, multilateration, trilateration is not to be interpreted as being limited to two or three transmitters. It is contemplated that any number of beacons/transmitters can be used in the employed radio navigation techniques.

As used herein, received signal strength (“RSS”) corresponds to the measured received strength of a radio signal. This can correspond to any wireless communication signal, such as WiFi, cellular, Bluetooth, NFC, etc., or combinations thereof.

The location estimation algorithm 114 includes tunable parameters used in the determination of position. Generally speaking, the tunable parameters of the location estimation algorithm 114 can be considered to be the parameters of the algorithm that contribute to the estimation of a location in a space, such as an [X,Y] coordinate in a two-dimensional map, an [X,Y,Z] coordinate in a three-dimensional map, a direction and magnitude of a vector from a reference point in a 2-D or 3-D map, etc.

More specifically, the tunable parameters in the location estimation algorithm 114 are those whose weights or coefficients result in an estimation in a particular direction and/or in a particular magnitude and to which a modification of those weights or coefficients results in a changed position determination in one or more directions.

Thus, the tunable parameters can include parameters such as the correlation between RSS values and position, including detection sensitivity, correlated location to mapped signal strength at various points in the digital map, etc. For example, if the location estimation algorithm 114 is a linear function of an RSS vector, the tunable parameters can be the coefficients that are multiplied by each RSS measurement. In another example, the tunable parameters can be those used in calculating distance from RSS using the standard RF transmission model equation (e.g., RSS power at a reference distance from a transmitter/beacon, reference distance from a transmitter/beacon, path loss exponent, etc.). Other examples of tunable parameters can include the number of detected beacons used in the determination, the relative weight of beacon signals in triangulation calculations, the amplitude criteria used in detecting and utilizing the signal, signal-to-noise sensitivity used, etc. The tunable parameters can include applying weights to the parameters of the location estimation algorithm 114 (such as the parameters of a Kalman filter algorithm). Weights can be applied to parameters such as a state (i.e. position) estimate based on current measurements, a state estimate based on prediction from a previous time step or sample, a sensor type in use to estimate position (e.g., machine vision, RF beacons, magnetometer, or a combination thereof), sensor instances (e.g., specific RF beacons among several available, specific mobile devices and their capabilities and/or characteristics, etc., as discussed further below), time periods (as discussed in the example below), Forbidden Zone boundaries and extent of intrusions, etc.

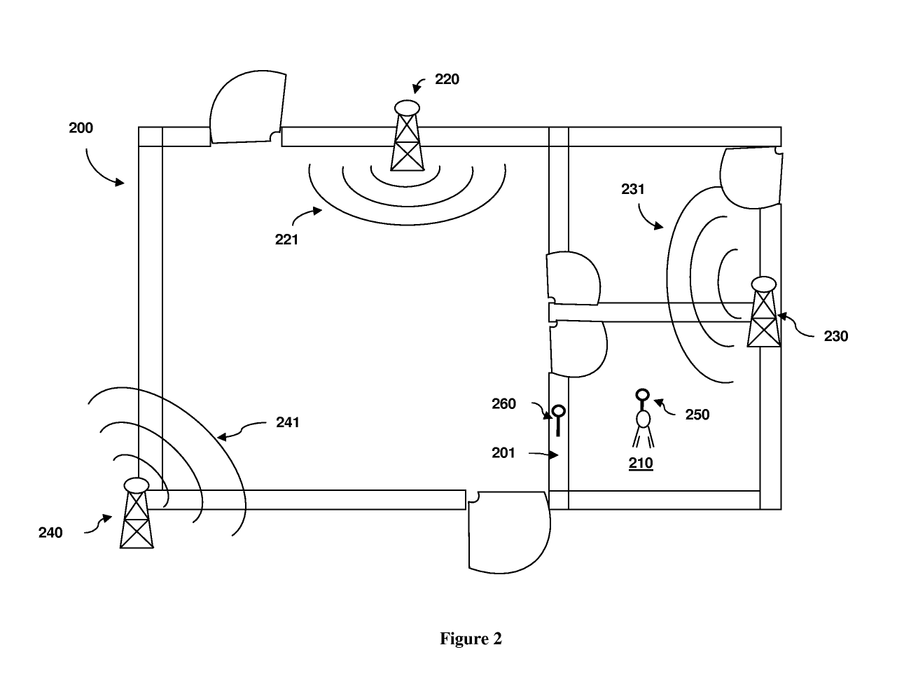

FIG. 2 provides an example of an execution of the location estimation algorithm 114 to determine a position based on radio signals. In this example, the position of a user having a handset 210 (corresponding to handset 110 of FIG. 1) is shown within a space such as a building 200 (e.g., an office building, house, etc.). As used herein, “space” is intended to refer to a physical space in which navigation or location identification is to be performed. Thus, a space can be 2-dimensional or 3-dimensional. Other examples of a space include a shopping mall, a store, a gaming environment, a healthcare facility, a ship, a geographic region, a right of way, a sporting venue, and an office space.

As shown in FIG. 2, beacons 220, 230, 240 emit radio signals 221, 231, 241, respectively. The RSS of signals 221, 231 and 241 is measured between the handset 210 and the beacons 220, 230, 240 and the position of the handset 210 within the space 200 is determined based on RSS measurements. As discussed above with regard to the system 100 in FIG. 1, this estimation can be performed by the handset 210, by one or more of the beacons 220, 230, 240, in another handset 210, in a server (such as server 130) or other computing device that communicates with the handset 210 or one or more of the beacons 220, 230, 240 and that measures the RSS, or in any combination of these devices.

Having measured the RSS of the signals 221, 231, 241, the location estimation algorithm 114 compares RSS values to a radio map that contains values of RSS vs. position for the space 200, by using a function or curve that relates RSS to distance from a beacon and then triangulating distances from multiple beacons (two or more of beacons 220, 230, 240), or any other technique that estimates position from RSS. Examples of suitable techniques that can be incorporated into location estimation algorithm 114 include those discussed above. The estimation can include adjustments for handset characteristics (e.g., signal reception capacity, sensitivity to signals, processing and/or memory limitations, etc.). The estimation can interpolate between RSS values in a radio map or RSS vs. distance table/curve.

In embodiments, the trajectory of handset 210 through the space 200 can be estimated by the location estimation algorithm 114, such as by analyzing a collection of past positions of the handset 210. Thus, a trajectory of the handset 210 can be the path through the space 200 with each of the past positions corresponding to a trajectory segment along the trajectory. The trajectory history of a handset or group of handsets can be calculated, stored, retrieved, and presented. Additionally, the future trajectory of a handset or group of handsets can be estimated based on the historical trajectory or trajectories of the handset or group of handsets.

If the estimation is correct, the determined position of the handset 210 corresponds to its real-world position. Thus, for example, in a location reporting application (such as a map or navigation application), its position is reported at marker 250.

However, due to interference, a change in the strength of the emissions 221, 231 and/or 241, or other factors, the determined position of the handset can be incorrect. For example, determined position 260 shows that the position of the handset 210 as being within a wall 201 of building 200.

Following the determination of the location by the location estimation algorithm 114, the location estimation module 115 can verify the determined position for correctness and correct an incorrect position (such as position 260 illustrated in FIG. 2) using a digital map of the space that includes one or more designated “Forbidden Zones”.

Generally speaking, a “Forbidden Zone” is a section of the digital map that corresponds to a region of the space that is physically inaccessible to a handset or otherwise represents a restricted area. Forbidden Zones can include areas that are completely or often physically inaccessible to handsets, such as closed areas, interiors of walls, and areas above normal human height (e.g. the space greater than 2.5 meters above ground level in an open atrium or outdoors). Forbidden Zones can also include areas where it is physically possible for a handset to be, but that a handset is not expected to be due to the area being restricted (e.g., high-security section of a government building, a top-secret research laboratory, a bank vault, etc.). Represented on a map, Forbidden Zones can be finite regions (with area or volumetric extent), planes (e.g. walls through which handsets cannot pass), or points (e.g., a pole modeled as a point with zero spatial extent, through which a handset cannot pass). As it pertains to the digital map, a Forbidden Zone can include or comprise a constraint that a handset cannot cross a boundary. An example of such a constraint is a wall through which handsets cannot pass and that is assumed to have zero thickness.

Within a Forbidden Zone there can exist an extent of intrusion once an intrusion has been determined. For example, an estimated position of a handset determined to be within a wall of a building is considered to be an intrusion. However, a detected intrusion of 3 inches is considered to be a “less bad” intrusion than a detected intrusion of 3 feet because (a) a detected intrusion of 3 inches might be considered to be within an acceptable margin of error given the sensitivity and precision of the systems being used, and (b) because the correction of a “3 feet” intrusion requires greater parameter adjustment than the “3 inch” intrusion to correct. In these situations, the extent of the intrusion can be used as an augmenting coefficient for a cost function.

Forbidden Zones can be static (e.g., in the case of walls or other permanent structures) or can be dynamic and can be updated. For example, the system can receive information from a security system in a building regarding the lock status of doors within the building. For any rooms whose doors are locked, the system can designate those rooms as “Forbidden Zones” within the building until the doors are unlocked and/or opened.

Forbidden Zones can have degrees of restriction rather than a binary, defined boundary. As such, an intrusion into a Forbidden Zone can vary according to the degree of restriction in which the estimated location falls. In one example, a Forbidden Zone can have a decay from a source point or boundary line, whereby the Forbidden Zone decays to zero over a distance on the digital map. This can be used to represent a physical constraint that becomes significantly more physically restrictive as the handset approaches the source. The decay factor can be used to modify a cost function by decreasing it according to the decay or gradual reduction of the degree of restriction represented by the Forbidden Zone. In an illustrative example, a Forbidden Zone can have a source of a furnace and an extending Forbidden Zone outward representative of the magnitude of the heat at different distances from the furnace. Thus, in this example, there can be areas in the space where the heat from the furnace can be felt but it is not dangerous or uncomfortable. In this area, the Forbidden Zone would be very decayed (or nullified altogether). As a person were to approach the furnace, the intensity of the heat would become greater and more uncomfortable and/or dangerous. Correspondingly, the restriction represented by Forbidden Zone similarly increases. In these cases, the measure of intrusion into the Forbidden Zone can be one of degrees of intrusion or extent of intrusion (such as a percentage of a “complete intrusion”) rather than a simple binary “yes/no” measure.

Forbidden Zones can be entered into a computer communicatively coupled to the system 100 (such as a handset 110, a server 130 or other computer system) by a human operator denoting points, lines, or shapes in a graphical user interface, importation of a graphics file, such as an architectural floor plan or view of the space, a combination thereof, or via other suitable techniques. Forbidden Zone descriptions can be provided to a server, a handset, a beacon, a multiple of these, or any combination of these.

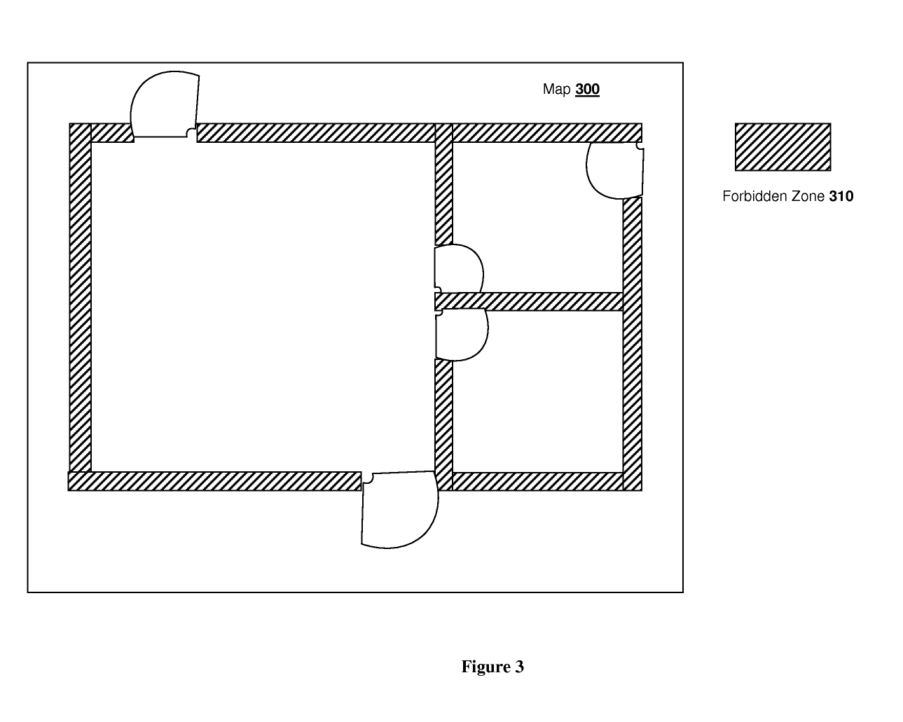

FIG. 3 provides an illustrative example of the digital map 300 of space (in this example, a building) 200 of FIG. 2 including Forbidden Zones 310, illustrated with the diagonal lines. In the illustrative example of FIG. 3, the Forbidden Zones 310 correspond to the walls of the building 200. In this example, the digital map 300 is a 2-D map of building 200. In a 3-D digital map/model, the Forbidden Zones 310 can also incorporate the floors and ceilings as well the space above a certain height off the floor (e.g. anything above 2.5-3 meters), such as in a high-arching ceiling or lobby of the building.

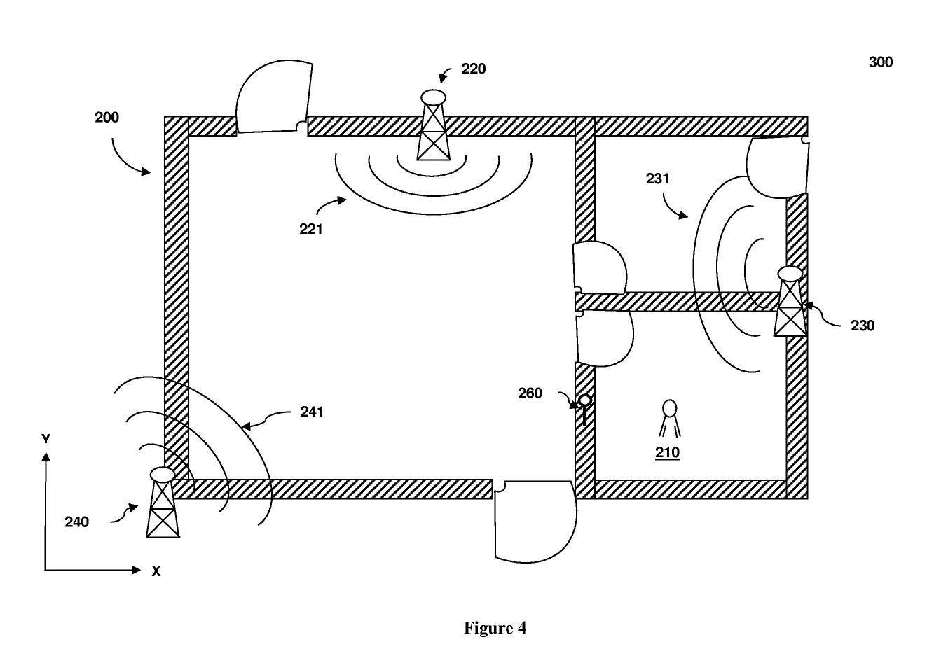

To verify the estimated position of handset 210, the location estimation module 115 compares the estimated handset position can against map 300 of the space 200 that includes the Forbidden Zones. If the estimated handset position is within a Forbidden Zone then the estimate might be incorrect. FIG. 4 illustrates an example of a map 300 of building 200, whereby the position estimate is the incorrect position estimate 260 of FIG. 2 (shown relative to the handset 210's actual position within the building 200).

Having determined that the position estimate 260 is within Forbidden Zone 310, the location estimation module can iteratively adjust the location estimation algorithm 114 or the parameters used by the location estimation algorithm 114 such that the intrusion of the position estimate 260 into the Forbidden Zone 310 is minimized. Henceforth, all references to adjustment of “algorithm parameters” can also refer to adjustment of the algorithm itself.

When an estimated position (such as position estimate 260) falls within a Forbidden Zone, the location estimation module 115 determines a cost function for the position estimate. The cost function can comprise a measure of the extent of intrusion of handset 210 into or intersections with Forbidden Zones. The cost function can use at least one metric, such as the total elapsed time of intrusion(s) or the total displacement of handset trajectory segments intruding into Forbidden Zones. The cost function can be a function of multiple weighting factors (e.g., a multi-dimensional function, an aggregated function, etc.). The weighting factors can include one or more of a binary weighting factor, a range of values, a spectrum of values, and floating point values. These weighting factors can represent one or more of a mobile device-specific weighting factor, a location-based weighting factor, a time period weighting factor, and a forbidden zone weighting factor.

Having determined the cost function, the location estimation module 115 can adjust algorithm parameters of the location estimation algorithm 114 to minimize the cost function over the single (most current) sample of position or across a determined trajectory into the Forbidden Zone 310. For example, an adjustment to a constraint of the algorithm used to correlate the detected signal for an RSS from a beacon to a position such that the particular RSS now results in a new position. In another example where a handset 210 detects signals from more than one beacon, an individual position determination can be made for each individual beacon and the one that deviates most from a “correct” position can be adjusted. Where triangulation is used, the triangulation algorithms can be adjusted to account for the changes to one or more of the signals as detected by the handset 210. This process can be performed iteratively until the cost function is minimized.

As the cost function is reduced, the location estimation algorithm 114 re-estimates the position using the updated parameters, which can result in an immediate or gradual correction in position. In certain situations, the updating of the parameters can be such that the estimated position is instantly changed to the newly estimated position (and, for example, in a map application, instantly reflected in the presented position on a map). In other situations, the changes in the parameters of the location estimation algorithm 114 may not result in an immediate change in the estimated instant position. As some parameters can affect the weight or confidence of state/position estimates based on measurements, predictions from previous states/positions, and/or certain constraints (Forbidden Zone locations and boundaries, time-related restrictions, etc.) as used in combination to determine an new overall position estimate. The effect of the combined parameters may not always be immediate on the position as they may be too gradual or be made with a focus in minimizing a predicted trajectory's intrusion into a Forbidden Zone.

In embodiments, the location estimation module 115 can analyze past estimated positions of handset 210 to determine the direction and/or magnitude of the position that require correction and, as such, the parameters of the algorithm that require adjustment. For example, for determined position 260 of FIG. 4, assume that a prior estimated position of handset 210 is estimated as being in the same room as the true position of handset 210 (i.e., to the right of or in a positive “X” direction relative the wall in FIG. 4). Because the subsequent position 260 is now shown as being in the Forbidden Zone 310, the location estimation module 115 determines intrusion into the Forbidden Zone 310 is in at least in a negative “X” direction as the movement from the prior position to position 260 is in the negative “X” direction. Consequently, the corrected position must be in a positive “X” direction. Thus, the parameters of location estimation algorithm 114 that are adjusted are those that would affect the “X” position in digital map 300 such that the cost function in the negative “X” direction is minimized.

This process can be repeated for multiple handsets and/or over time. By executing repeatedly over time and/or for multiple handsets, the algorithm re-calibrates itself over time, minimizes estimated intrusion into Forbidden Zones, converges on or towards an optimal algorithm parameters and/or algorithm steps, and thus accommodates changes in conditions in or near the space (e.g. changes in access points, human traffic, physical structure, or electromagnetic environment).

The process can be performed for each sampled position (i.e. trajectory segment) in a handset 200's immediate past trajectory (i.e., for the handset's current incursion into the space 200), whereby the parameters to the algorithm 114 are applied to each sampled position. As the location estimation module 115 performs the iterative analysis to each sampled position, it performs checks of corrected positions for each sampled position to ensure that a correction to one or more of the sampled positions does not result in an increased cost function (or new cost functions) for other sampled positions in the trajectory. Continuing the example of FIG. 4, an adjustment to the location estimation algorithm 114 can result in a correction of a current estimated position 260 such that it is removed from the Forbidden Zone. However, for prior RSS samples, a similar adjustment might result in prior estimated locations located in Forbidden Zones. Thus, adjustments to the location estimation algorithm 114 to minimize the cost function executed by the location estimation module 115 can be such that the cost functions of a number of prior estimated locations along a trajectory are minimized. For sufficient prior trajectory segments deemed to be “correct” (e.g., above a threshold of consecutive non-Forbidden Zone positions, a percentage of all positions being non-Forbidden Zone positions, etc.), the location estimation module 115 can only the instant trajectory segment to be corrected or adjusted.

In the analysis of a trajectory of handset 210 through a space 200, the location estimation module 115 can analyze the RSS from a particular beacon 220,240,260 throughout the trajectory and plot the changes in the received RSS over time against an expected or predicted signal decay. A sudden change in RSS between sampled signal detection iterations or in a short amount of sampling iterations can be indicative of a source of local interference (e.g., an object capable of causing interference located in the space such that it interferes with the RF signal between the beacon and the handset 210 at a point along the trajectory) rather than an error of the algorithm as a whole. If a difference in sampled RSS for a signal and past RSS for the signal from the same source exceeds a threshold difference within a certain period of time, the location estimation module 115 can determine that the deviation is caused by a localized source of interference or variation of signal strength and perform a temporary or decreased adjustment to the parameters of location estimation algorithm 114.

If multiple handsets 210 are present in a space 200 and one or more of them are determined to be within one or more Forbidden Zones, it may not be possible to adjust the location estimation algorithm 114 uniformly as applied to all handsets 210 (and/or all beacons 220, 230, 240) to find a solution that reduces and/or maintains all cost functions for all handsets 210 at zero. In other words, a solution such that no devices remain estimated as being inside a Forbidden Zone may not exist for a given environment. In these situations, the location estimation module 115 can select a solution (i.e., one or more modifications to the parameters of the location estimation algorithm 114) such that the intrusion into the Forbidden Zones are minimized for all handsets 210. This can include selecting a solution whereby the number of handsets 210 estimated to intrude a Forbidden Zone is minimized, a solution whereby the degree of intrusion by any single device is minimized, or a combination thereof.

In embodiments, a handset 210 can have an associated Personal Forbidden Zone applicable to the handset within a space 200. The Personal Forbidden Zone can correspond to a radius from the handset 210 beyond which a new position is unlikely to be within a certain period of time or trajectory segments. In an estimated trajectory of a handset 210, a difference between a prior estimated position and a new estimated position that exceeds likely or possible distance traveled by the handset 210 in that time can be deemed to fall within the Personal Forbidden Zone. The Personal Forbidden Zone can further be based on the digital map of the space 200, such that a venue or location and a possible ability for the handset 210 to move (or that the handset 210 is likely to move) can be determined. For example, for a space 200 corresponding to an office, a variance between estimated positions in a trajectory extending beyond a threshold walking or running speed for a person can result in a violation of a Personal Forbidden Zone. Conversely, if an estimated position of a handset is on a highway, the Personal Forbidden Zone can be larger to account for the possibility that the handset 210 is on a moving vehicle.

In embodiments, the RSS can be measured between two or more beacons, and the distance between the beacons estimated. From such distance estimates, the relative position of the beacons can be estimated. A map of beacon relative positions can be fitted to a map of the physical space, by a human operator or via computer algorithm interpolating the relative positions of a map according to a reference point or correlation. The locations of the beacons in the space and the time-varying intra-beacon RSS measurements can be used to estimate a time-varying radio map (of RSS as a function of location). Such a radio map can be used, along with measurement of RSS between a handset and beacon(s), to estimate the handset position.

As discussed above, handsets 210 can themselves function as beacons in certain embodiments. As such, the systems and methods of the inventive subject matter can involve handset-only environments without requiring static, stationary beacons. In these embodiments, RSS is measured between handsets 210 rather than between a handset 210 and one or more beacons 220, 230, 240. Handset positions are estimated based on RSS measurements between handsets 210, using Forbidden Zones as position constraints, and by iteratively adjusting algorithm parameters as discussed above.

In embodiments, the system can function as a hybrid of the handset-beacon and handset-only embodiments, where handset positions for various handsets can be estimated based on the RSS measurements between the handsets as well as those of the beacons.

The location estimation module 115 can be configured to learn from historical data. Historical data regarding the radio environment of a space can be stored and statistical analysis performed by location estimation module 115 to detect patterns in the radio environment of the space over time. The location estimation module 115 can then incorporate determined patterns in producing further estimates or future calibrations to the location estimation algorithm 114. For example, in a shopping mall, there can be patterns of human traffic as a function of time of day or day or week, and these patterns may affect the radio environment, and thus the algorithm parameters, and the algorithm can incorporate a history of these patterns in future calibrations or estimates.

In embodiments, the location estimation module 115 can be configured to correlate detected patterns with types of spaces. As such, the tunable parameters of the location estimation algorithm 114 can include those parameters adjusted to account for the detected patterns. For example, in position determination techniques using magnetometers to determine position (for example, by measuring magnetic field direction, strength and/or flux and comparing the measurements to a reference map), an analysis of the magnetic field strength of a space corresponding to an office over a period of time can show that there is a consistent increase in the magnetic field strength at 8:00AM and a drop in the magnetic field strength at about 5:00 PM for five days in a row with a two day gap in between (corresponding to lights, computers and other equipment being turned on in the morning and then turned off in the evening during weekdays). Conversely, a space corresponding to a bar would have corresponding increases and drops in the corresponding magnetic field at night until around midnight or 1:00 AM. The location estimation module 115 can correlate these patterns to a particular venue, type of venue, time of day, day of week, weekends, holidays, time zone, state, country, etc. by receiving information associated with a particular digital map and a system time for the digital map. This can be provided via manual entry, retrieved from databases, etc. In embodiments, a digital map of a space can include identifiers associated with the geographic location, the name of the venue, the type of venue (e.g., business, what type of business, residential, etc.). Thus, the parameters associated with correlating particular values of a detected magnetic quality can be adjusted based on the expected values for a particular day or time according to the pattern.

In these embodiments, the location estimation algorithm 114 can be adjusted by the location estimation module 115 according to the detected patterns to account for differences in signals (in this example, magnetic field strength but can similarly apply to RF signals or other wireless signals). Similarly, the location estimation module 115 can adjust the boundaries or weights of Forbidden Zones based on the patterns such that a Forbidden Zone is extended to cover more of a space during the periods of low activity (e.g. reflecting times of a day or weekend when a business is closed and/or no one is likely to be there or should be there).

Different weights (e.g. cost function weights) can be applied to different handsets. For example, a handset associated with a store clerk in a shopping mall can be exempted from a Forbidden Zone constraint, such as entry into a restricted-access area (e.g. a store stockroom), because that person can access that area, unlike the persons associated with other handsets.

Different weights (e.g. cost function weights) can be applied to different time periods. For example, if maintenance personnel frequent certain areas of a shopping mall during non-business hours then RSS data from a handset in such a time period can be ignored or be considered with lower weighting or emphasis.

Different weights can be applied to different Forbidden Zones, since intrusion into a certain Forbidden Zone might be rare although not impossible. For example, it would be rare for a handset to enter into a decorative water fountain in a shopping mall or into a cage housing a gorilla at a zoo.

The above-mentioned weights can have variable values. In other words, they need not be discrete binary weights but rather can be continuous real (floating point) numbers. These weights can also be applied to the parameters of the location estimation algorithm 114 (such as those of a Kalman filter algorithm) to modify these parameters.

Individual handsets can be identified and associated with position information in at least one Space. Such identification can be performed via a device identifier, software application identifier, user identifier, probabilistic estimation based on device characteristics, or other means.

While the techniques of the inventive subject matter are described in embodiments using RF signal strength for position estimation, it is contemplated that the systems and methods described herein can be applied to any position determination techniques that are based on a detected quality or characteristic of the environment (or a combination of more than one of these techniques). Examples of these techniques include the use of magnetometer data (as discussed in the example above), inertial measurement units (gyros, accelerometers, etc.), barometers (using changes in air pressure to determine relative altitude change), image recognition (e.g., recognizing an object known to be at a particular location and estimating position based on the location of the object), visual odometry (estimating relative displacement and rotation based on tracking features in a camera's field of view), GPS, etc.

Position estimates can be initialized or aided by at least one addition navigation data source, such as GPS, dead reckoning, visual flow, feature tracking, scene recognition, image recognition, object recognition, etc.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An location estimation system comprising
a computer readable non-transitory memory configured to store:
a digital map of an area comprising at least one forbidden zone;
software instructions representing a location estimation algorithm comprising tunable parameters; and
a location estimation module coupled with the memory and configured to execute the instructions on a processor, the processor, according to the instructions, further configured to:
estimate a location of a mobile device within the area as a function of the location estimation algorithm and based on signal strengths of signals received from at least one beacon;
compare the location to the digital map to identify the location as falling within the at least one forbidden zone;
adjusting the tunable parameters of the location estimation algorithm to reduce a result of a cost function reflecting intrusion of the mobile device into the at least one forbidden zone; and
update at least one of location estimation algorithm and the tunable parameters of the location estimation algorithm in the memory based on the reduced result from the cost function.

2. The system of claim 1, wherein the processor is further configured to repeat estimation the location of the mobile device using updated tunable parameters.

3. The system of claim 1, wherein the at least one beacon comprises at least one of the following: an access point, a cell tower, a transmitter, and a radio station.

4. The system of claim 1, wherein the at least one beacon comprises another mobile device.

5. The system of claim 1, further comprising a server that includes the memory and the location estimation module.

6. The system of claim 1, wherein the mobile device comprises the memory and the location estimation module.

7. The system of claim 1, wherein the mobile device comprise at least one of the following: a cell phone, a tablet, a phablet, a medical device, a sensor, a toy, and a vehicle.

8. The system of claim 1, wherein the at least one forbidden zone comprises at least one of the following: a restricted space, and a physical barrier.

9. The system of claim 1, wherein the cost function is based on at least one of the following metrics: an elapsed time of intrusion, a displacement of trajectory segments intruding into the at least one forbidden zone, a degree of intrusion into the at least one forbidden zone, and a number of boundary violations.

10. The system of claim 1, wherein the processor is further configured to provide an updated estimated location based on the updated tunable parameters.

11. The system of claim 1, wherein the digital map further comprises detected patterns as tunable parameters.

12. The system of claim 11, wherein the detected patterns reflect at least one of the following: a radio environment, an environment change with respect to time, human traffic, and a historical pattern.

13. The system of claim 1, wherein the cost function is a function of multiple weighting factors.

14. The system of claim 13, wherein the weighting factors represent at least one of the following: a mobile device-specific weighting factor, a location-based weighting factor, a time period weighting factor, and a forbidden zone weighting factor.

15. The system of claim 13, wherein the weighting factors comprise at least one of the following: a binary weighting factor, a range of values, a spectrum of values, and floating point values.

16. The system of claim 1, wherein the digital map represents at least one of the following types of areas: a shopping mall, a store, a gaming environment, a building, a healthcare facility, a ship, a geographic region, a right of way, a sporting venue, and an office space.

17. The system of claim 1, wherein the signals comprises at least one of the following types of signals: Bluetooth, WiFi, WiMAX, WiGIG, GSM, CDMA, and Zigbee.
